(19) United States
(12) Patent Application Publication
(10) Pub. No.: US 2021/0291081 A1
(43) Pub. Date: Sep. 23, 2021

(54) PRECIPITATE REMOVING APPARATUS AND COOLING WATER CIRCULATION SYSTEM PROVIDED WITH SAME

(71) Applicant: TOYOTA BOSHOKU KABUSHIKI KAISHA

(72) Inventor: Masasuke NAGATA, Aichi (JP)

(73) Assignees: TOYOTA BOSHOKU KABUSHIKI KAISHA, Aichi (JP); TOYOTA BOSHOKU KABUSHIKI KAISHA, Aichi (JP)

(21) Appl. No.: 16/317,982

(22) PCT Filed: Jul. 24, 2017
(86) PCT No.: PCT/JP2017/026725

§ 371 Date: Jan. 15, 2019

(30) Foreign Application Priority Data
Jul. 28, 2016 (JP) 2016-148950

(51) Int. Cl. B01D 21/24; B01D 21/00; C02F 1/00

(52) U.S. Cl. CPC B01D 21/2472; B01D 21/2416; C02F 2103/023; C02F 1/001; C02F 2001/007; B01D 21/0012

(57) ABSTRACT

The present precipitate removing apparatus is a precipitate removing apparatus for removing a precipitate, precipitating on the bottom of a water tank that stores a liquid (cooling water), and includes an injector provided in the water tank, and an introduction pipe for introducing the liquid in the water tank to the injector. The introduction pipe is provided with a pressure pump for pumping the liquid in the water tank to the injector.

### TECHNICAL FIELD

The present invention relates to a precipitate removing apparatus and a cooling water circulation system provided with the same, and more particularly to a precipitate removing apparatus that removes a precipitate, precipitating on the bottom of a water tank that stores liquid, and a cooling water circulation system provided with the same.

### BACKGROUND ART

As illustrated in FIG. 9, a conventional cooling tower 105 is configured such that cooling water increased in temperature returns to a water sprinkling tank 105a and is sprinkled from above filling materials 105b to flow down among the filling materials 105b, for example. When air taken in by a blower 105c through a suction port passes among the filling materials 105b, the air and the cooling water come into contact with each other to evaporate some of the cooling water, thereby cooling remaining cooling water by latent heat of vaporization. Then, the cooling water cooled is stored in a water tank 105d provided at a lower portion and pumped to a chiller machine or the like.

During operation of the cooling tower 105, outside air is taken into the tower to cool the cooling water, so that dust and the like, together with the outside air, are mixed with cooling water in the water tank 105d in the tower. When the operation of the cooling tower 105 is stopped, scales and the like adhering to the filling materials 105b are peeled off to be mixed with the cooling water in the water tank 105d. The dust, scales, and the like mixed with the cooling water in the water tank 105d mix with bacteria, algae, and the like to cause slime to easily occur, so that a precipitate P precipitates and accumulates on the bottom of the water tank 105d.

Thus, various techniques for removing a precipitate, precipitating on the bottom of a water tank of a cooling tower, have been proposed (e.g., refer to Patent Literatures 1 and 2). Patent Literature 1 discloses a technique in which a worker moves a movable water supply pipe to the vicinity of a precipitate in a water tank to cause cooling water together with the precipitate to be supplied to a filtering device through the water supply pipe. Patent Literature 2 discloses a technique in which a weir is provided so as to surround the periphery of an inflow port formed at the bottom of the water tank to allow a worker to clean and remove a foreign matter blocked by the weir.

### CITATIONS LIST

### Patent Literatures

Patent Literature 1: Japanese Unexamined Patent Application Publication No. 2004-188270
Patent Literature 2: Japanese Unexamined Patent Application Publication No. 2009-168401

### SUMMARY OF INVENTION

### Technical Problems

Unfortunately, the techniques disclosed in Patent Literatures 1 and 2 described above are for removing a precipitate manually by a worker, which is a very complicated operation. The above-mentioned problem relating to removal of a precipitate may occur not only in a water tank of a cooling tower but also in a water tank for storing various liquids.

The present invention is made in light of the above-described circumstances, and an object thereof is to provide a precipitate removing apparatus capable of easily removing a precipitate, precipitating on the bottom of a water tank.

### Solutions to Problems

In order to solve the above problem, the invention as defined in claim 1 relates to a precipitate removing apparatus for removing a precipitate, precipitating on the bottom of a water tank that stores a liquid, the precipitate removing apparatus comprising: an injector provided in the water tank; and an introduction pipe for introducing a liquid in the water tank to the injector, the introduction pipe being provided with a pressure pump for pumping the liquid in the water tank to the injector.

The invention as defined in claim 2 relates to the precipitate removing apparatus according to claim 1, wherein the introducing pipe is provided with filter means for removing impurities contained in the liquid flowing through the introducing pipe.

The invention as defined in claim 3 relates to the precipitate removing apparatus according to claim 1 or 2, wherein the injector includes a small-diameter nozzle, a large-diameter nozzle that is disposed so as to have an axis aligning with an axis of the small-diameter nozzle and a discharge port positioned downstream of a discharge port of the small-diameter nozzle in a discharge direction, and intake ports for taking the liquid in the water tank into the large-diameter nozzle to generate negative pressure in front of the discharge port of the small-diameter nozzle.

The invention as defined in claim 4 relates to the precipitate removing apparatus according to claim 3, wherein the large-diameter nozzle is supported by the small-diameter nozzle using a plurality of support pieces, and the intake ports are formed among the plurality of support pieces.

The invention as defined in claim 5 relates to the precipitate removing apparatus according to claim 3 or 4, wherein the large diameter nozzle is provided with a nozzle hole formed in a tapered shape increasing in diameter toward the discharge port.

The invention as defined in claim 6 relates to the precipitate removing apparatus according to any one of claims 1 to 5, wherein a plurality of the injectors are juxtaposed along a side wall of the water tank.

The invention as defined in claim 7 relates to the precipitate removing apparatus according to any one of claims 1 to 6, wherein the water tank is provided at its bottom with an outflow port communicating with the introduction pipe, and a shielding wall erected at a position facing an injection direction of the injector while surrounding a periphery of the outflow port.

The invention as defined in claim 8 relates to the precipitate removing apparatus according to any one of claims 1 to 7, wherein the injector is provided in the water tank provided in the cooling tower.

The invention as defined in claim 9 relates to the precipitate removing apparatus according to claim 8, wherein the introduction pipe has one end connected to the injector, and the other end connected to a feed path of a cooling-tower-side circulation path for circulating cooling water between the cooling tower and a chiller machine.

In order to solve the above problem, the invention as defined in claim 10 relates to a cooling water circulation system comprising: a cooling-tower-side circulation path for circulating cooling water between a cooling tower and a chiller machine; and the precipitate removing apparatus according to any one of claims 1 to 9, wherein the injector is provided in the water tank provided in the cooling tower.

### Advantageous Effects of Invention

The precipitate removing apparatus of the present invention is configured to include the injector provided in the water tank, and the introduction pipe for introducing the liquid in the water tank into the injector, the introduction pipe being provided with the pressure pump for pumping the liquid in the water tank into the injector. This allows the pressure pump to pump the liquid in the water tank into the injector via the introduction pipe, and the injector to inject the liquid to remove the precipitate from the bottom of the water tank. As a result, the precipitate, precipitating on the bottom of the water tank, can be easily removed.

When the introduction pipe is provided with the filter means, the filter mean removes impurities contained in the liquid flowing through the introduction pipe to improve the liquid in water quality.

When the injector includes a small-diameter nozzle, a large-diameter nozzle, and intake ports, taking the liquid in the water tank into the large-diameter nozzle from the intake ports causes negative pressure to be generated in front of the discharge port of the small-diameter nozzle. The negative pressure causes suction force to draw out the liquid from the discharge port of the small-diameter nozzle at a higher flow velocity than the liquid flowing through the introduction pipe. Then, the liquid taken in through the intake ports is combined with the liquid drawn out from the discharge port of the small-diameter nozzle to be injected toward the precipitate through the discharge port of the large-diameter nozzle. This enables the precipitate to be removed by the liquid injected by the injector having a simple structure.

When the large-diameter nozzle is supported by the small-diameter nozzle using a plurality of support pieces and the intake ports are formed among the plurality of support pieces, liquid is effectively taken into the large-diameter nozzle from the intake ports to cause a larger negative pressure to be generated in front of the discharge port of the small-diameter nozzle. This further increases the injection force of the injector.

When the nozzle hole of the large-diameter nozzle is formed in a tapered shape increasing in diameter toward the discharge port, the injection range of the injector is widened.

When a plurality of the injectors is juxtaposed along the side wall of the water tank, the plurality of the injectors can remove precipitates, precipitating over a wide range on the bottom of the water tank, using liquid injected by the injectors.

When the water tank is provided at its bottom with the outflow port and the shielding wall erected, the precipitate removed from the bottom of the water tank, using the liquid injected by the injector collides with the shielding wall. Then, the precipitate is finely dispersed and smoothly guided into the outflow port by the shielding wall.

When the injector is provided in the water tank provided in the cooling tower, the precipitate, precipitating on the bottom of the water tank of the cooling tower, can be easily removed.

In addition, when the introduction pipe has one end connected to the injector, and the other end connected to the feed path of the cooling-tower-side circulation path, the introduction pipe, and thus the apparatus can be easily installed.

The cooling water circulation system of the present invention is configured such that the precipitate removing apparatus described above is provided and the injector is provided in the water tank provided in the cooling tower. This allows the pressure pump to pump the cooling water in the water tank of the cooling tower into the injector via the introduction pipe during the operation of the cooling tower, so that the precipitate is removed from the bottom of the water tank of the cooling tower using the cooling water injected by the injector. As a result, the precipitate, precipitating on the bottom of the water tank, can be easily removed.

### BRIEF DESCRIPTION OF DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a general schematic view of a cooling water circulation system according to an example.

FIG. 2 is an enlarged view of a main part of FIG. 1, and is an explanatory view for illustrating a precipitate removing apparatus according to an example.

FIG. 3 is a perspective view schematically illustrating the precipitate removing apparatus.

FIG. 4 is a side view of an injector according to an example.

FIG. 5 is a view as viewed from arrow V in FIG. 4.

FIG. 6 is a sectional view taken along line VI-VI of FIG. 5.

FIG. 7 is a side view of a water impurity separation device according to an example, illustrating a part of it as a sectional view.

FIG. 8 is a view for illustrating action of the precipitate removing apparatus, FIG. 8(a) illustrating a state in which precipitates precipitate on the bottom of a water tank, and FIG. 8(b) illustrating a state in which the precipitates are removed from the bottom of a water tank.

FIG. 9 is an explanatory view for illustrating a conventional cooling tower.

### DESCRIPTION OF EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

<Precipitate Removing Apparatus>

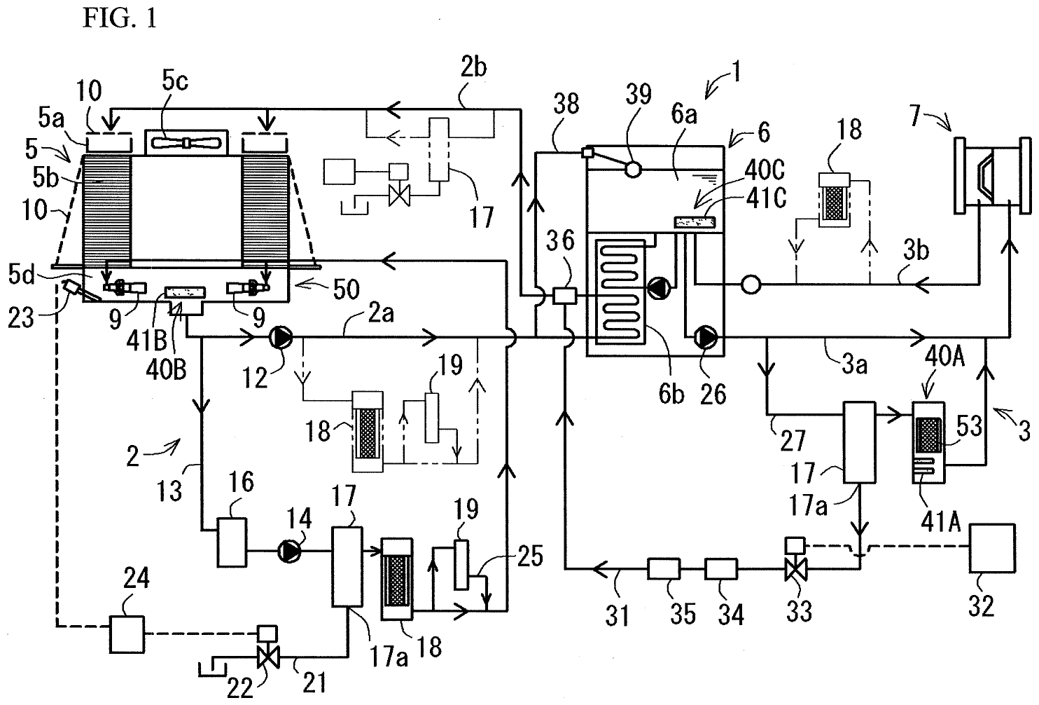

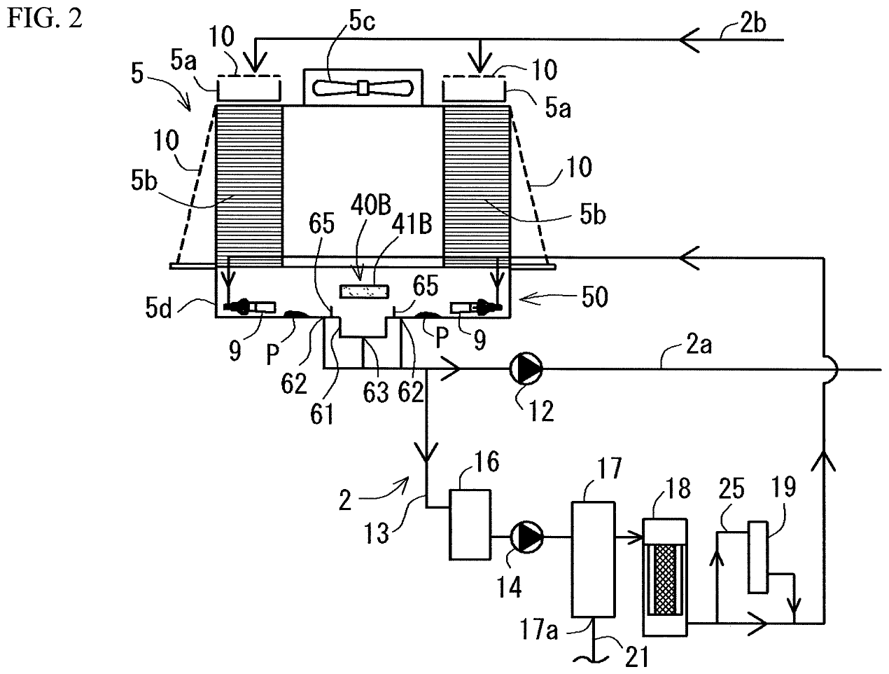

A precipitate removing apparatus according to the present embodiment is a precipitate removing apparatus (50) for removing a precipitate (P), precipitating on the bottom of a water tank (5d) that stores a liquid, and includes an injector (9), and an introduction pipe (13) for introducing the liquid in the water tank to the injector, the introduction pipe being provided with a pressure pump (14) for pumping the liquid in the water tank to the injector (e.g., refer to FIGS. 1 and 2, etc.). The introduction pipe usually has one end connected to the injector.

The precipitate removing apparatus according to the present embodiment may include an aspect in which the introducing pipe (13) is provided with filter means (16 and 17) for removing impurities contained in the liquid flowing through the introducing pipe (e.g., refer to FIG. 2, etc.), for example.

The aspect described above may be configured as follows: the first filter means (16) is provided upstream of the pressure pump (14) of the introduction pipe (13); the second filter means (17) is provided downstream of the pressure pump of the introduction pipe; and the second filter means (17) is capable of removing impurities smaller than impurities removable by the first filter means (16) (e.g., refer to FIGS. 1 and 2, etc.), for example. This allows the first filter means to remove relatively large impurities upstream of the pressure pump, and the second filter means to remove relatively small impurities downstream of the pressure pump. As a result, impurities can be effectively removed while damage or the like to the pressure pump is prevented.

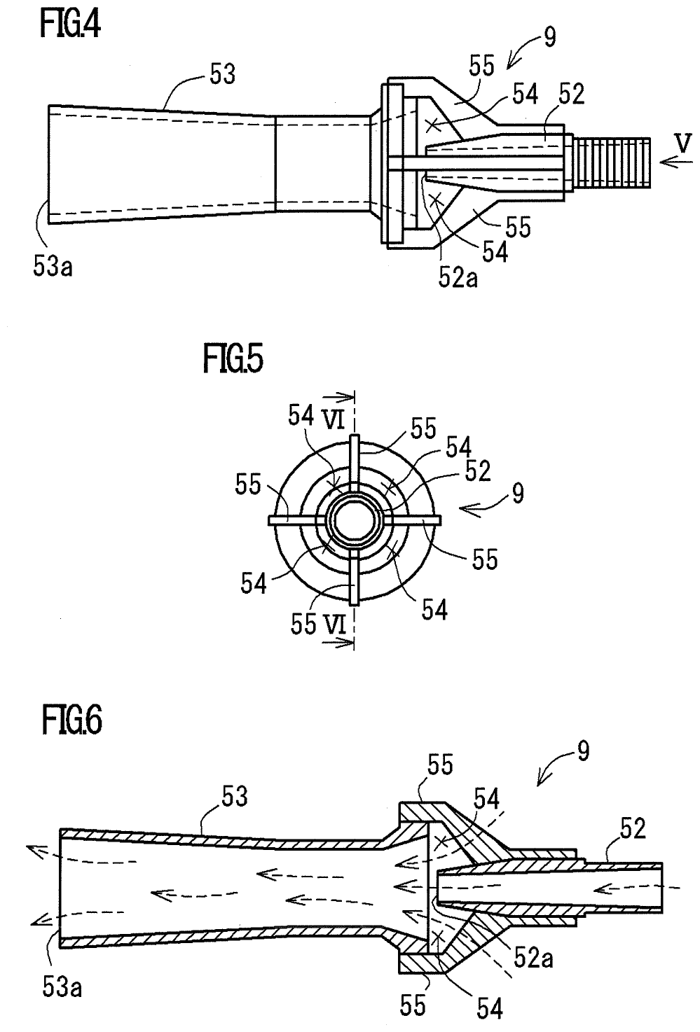

The precipitate removing apparatus according to the present embodiment may include an aspect in which the injector (9) includes: a small-diameter nozzle (52); a large-diameter nozzle (53) disposed so as to have an axis aligning with an axis of the small-diameter nozzle and a discharge port positioned downstream of a discharge port of the small-diameter nozzle in a discharge direction; and intake ports (54) for taking a liquid in the water tank (5d) into the large-diameter nozzle to generate a negative pressure in front of the discharge port of the small-diameter nozzle (e.g., refer to FIGS. 4 to 6, etc.), for example.

The aspect described above may be configured such that the large-diameter nozzle (53) is supported by the small-diameter nozzle (52) using a plurality of support pieces (55), and the intake ports (54) are formed among the plurality of support pieces, for example. In addition, the large-diameter nozzle (53) may be provided with a nozzle hole formed in a tapered shape increasing in diameter toward the discharge port (53a), for example.

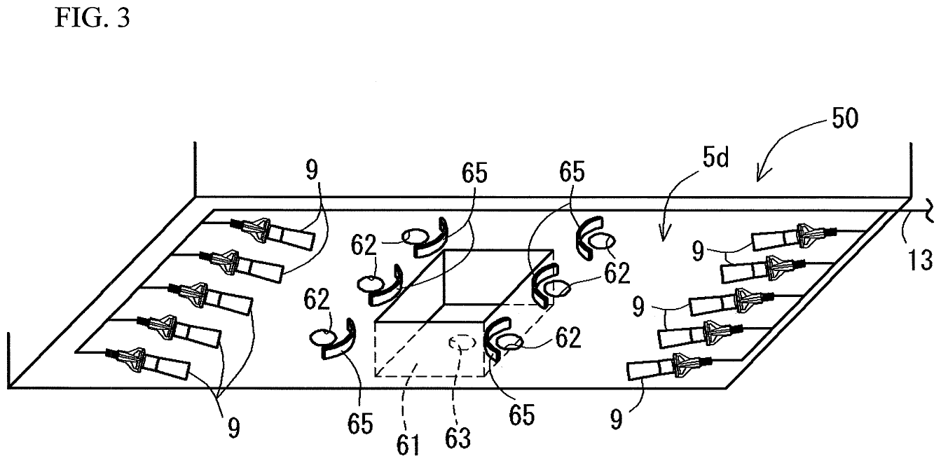

The precipitate removing apparatus according to the present embodiment may include an aspect in which a plurality of the injectors (9) is juxtaposed along a side wall of the water tank (5d) (e.g., refer to FIG. 3, etc.), for example.

The precipitate removing apparatus according to the present embodiment may include an aspect in which the water tank (5d) is provided at its bottom with an outflow port (62) communicating with the introduction pipe (13), and a shielding wall (65) erected at a position facing an injection direction of the injector (9) while surrounding the periphery of the outflow port (62) (e.g., refer to FIG. 3, etc.), for example.

The precipitate removing apparatus according to the present embodiment may include an aspect in which the injector (9) is provided in the water tank (5d) provided in a cooling tower (5) (e.g., refer to FIG. 2, etc.), for example. This aspect may be configured such that the introduction pipe (13) has one end connected to the injector (9), and the other end connected to a feed path (2a) of a cooling-tower-side circulation path (2) for circulating cooling water between the cooling tower (5) and a chiller machine (6), for example.

<Cooling Water Circulation System>

A cooling water circulation system according to the present embodiment includes the cooling-tower-side circulation path (2) for circulating cooling water between the cooling tower (5) and the chiller machine (6), and the precipitate removing apparatus (50) according to the embodiment described above, wherein the injector (9) is provided in the water tank (5d) provided in the cooling tower (5) (e.g., refer to FIGS. 1 and 2, etc.).

The reference numeral in parentheses of each component described in the above embodiment indicates a correspondence with a specific component described in an example to be described below.

### EXAMPLE

Hereinafter, the present invention will be described in detail using an example with reference to the drawings.

### (1) Configuration of Cooling Water Circulation System

As illustrated in FIG. 1, a cooling-water circulation system 1 according to the present example includes a cooling-tower-side circulation path 2 (also referred to as a “primary circulation path”) for circulating cooling water between a cooling tower 5 and a chiller machine 6, and a chiller-machine-side circulation path 3 (also referred to as a “secondary circulation path”) for circulating the cooling water between the chiller machine 6 and a cooling target part 7. Examples of the cooling target part 7 include an injection molding device, a press working device, a welding device, a heating device, a trimming device, and the like.

The cooling tower 5 includes a water sprinkling tank 5a for storing and sprinkling cooling water increased in temperature fed from the chiller machine 6, a filling material 5b for cooling the water sprinkled from the water sprinkling tank 5a with air, a blower 5c for taking in outside air through a suction port to allow the outside air to pass through the inside of the filling material 5b, and a water tank 5d for storing the cooling water dropped while being cooled by the filling material 5b. The water tank 5d is provided in its inside with a straight pipe 41B made of porous ceramic, constituting a microbubble generator 40B for generating microbubbles in cooling water in the water tank 5d, and an injector 9 constituting a precipitate removing apparatus 50 described below. In addition, a multifunctional net 10 is stretched so as to cover the suction port and the water sprinkling tank 5a of the cooling tower 5. The multifunction net 10 not only prevents algae, slime, legionella bacteria, and the like from occurring in the cooling tower 5 but also improves cooling efficiency therein.

The chiller machine 6 includes a tank 6a for storing cooling water increased in temperature fed from the cooling target part 7, and a heat exchanger 6b for cooling the cooling water in the tank 6a. The tank 6a is provided in its inside with a straight pipe 41C made of porous ceramics, constituting a microbubble generator 40C for generating microbubbles in cooling water in the tank 6a.

The cooling-tower-side circulation path 2 includes a feed path 2a that is connected at one end to the water tank 5d of the cooling tower 5 and at the other end to the heat exchanger 6b of the chiller machine 6, and a return path 2b that has one end connected to the heat exchanger 6b of the chiller machine 6 and the other end connected to the water sprinkling tank 5a of the cooling tower 5. The feed path 2a is provided with a pressure pump 12 for pumping the cooling water in the water tank 5d of the cooling tower 5 toward the heat exchanger 6b of the chiller machine 6. In addition, an introduction pipe 13, constituting the precipitate removing apparatus 50 described below, has one end connected to the feed path 2a upstream of the pressure pump 12.

The chiller-machine-side circulation path 3 includes a feed path 3a that has one end connected to the tank 6a of the chiller machine 6 and the other end connected to the cooling target part 7, and a return path 3b that has one end connected to the cooling target part 7 and the other end connected to the tank 6a of the chiller machine 6. The feed path 3a is provided with a pressure pump 26 for pumping cooling water in the tank 6a of the chiller machine 6 toward the cooling target part 7. In addition, a bypass path 27 is provided downstream of the pressure pump 26 in the feed path 3a. The bypass path 27 includes the water impurity separation device 17 for removing impurities contained in cooling water, and the microbubble generator 40A for generating microbubbles in cooling water. The microbubble generator 40A includes a straight pipe 41A made of porous ceramics, and a container 53 containing the tourmaline granules. Thus, the microbubble generator 40A has not only a function of generating microbubbles in cooling water but also a function of bringing the cooling water into contact with tourmaline granules to form tourmaline-treated water.

As illustrated in FIG. 7, the water impurity separation device 17 includes a housing 70 provided with an inflow port 70a and an outflow port 70b. The housing 70 is provided in its inside with a baffle plate 71 such that its internal space is vertically partitioned into an upper filtration chamber S1 and a lower precipitation chamber S2. The upper filtration chamber S1 contains a plurality of filter media 72 therein. The housing 70 is provided at its bottom with a drain port 17a communicating with the lower precipitation chamber S2.

The cooling-tower-side circulation path 2 and the chiller-machine-side circulation path 3 are connected by a first connection pipe 31 for introducing cooling water circulating in the chiller-machine-side circulation path 3 into the cooling-tower-side circulation path 2. The first connection pipe 31 connects the drain port 17a of the water impurity separation device 17 and the return path 2b of the cooling-tower-side circulation path 2.

The first connection pipe 31 is provided with an electric valve 33 that opens and closes the first connection pipe 31 by opening and closing control of a control unit 32. The control unit 32 has a timer function that enables a drainage time period and the amount of exchanging drainage to be arbitrarily set in accordance with water quality conditions, a temperature setting state, and the like of cooling water. The first connection pipe 31 is provided with a constant flow valve 34 of a washer rubber type. The first connection pipe 31 is also provided with a chuck valve 35. The first connection pipe 31 is provided at its one end with a differential pressure injector 36 disposed in a pipe constituting the cooling-tower-side circulation path 2. The differential pressure injector 36 is configured to be able to introduce cooling water flowing through the first connection pipe 31 to the cooling water flowing through the pipe constituting the cooling-tower-side circulation path 2, under a lower pressure and at a smaller flow rate than the cooling water flowing through the pipe.

The cooling-tower-side circulation path 2 and the chiller-machine-side circulation path 3 are connected by a second connection pipe 38 for introducing the cooling water circulating in the cooling-tower-side circulation path 2 to the chiller-machine-side circulation path 3. The second connection pipe 38 connects the feed path 2a of the cooling-tower-side circulation path 2 and the tank 6a of the chiller machine 6. The second connection pipe 38 is provided at its one end with a float valve 39 for opening and closing the second connection pipe in accordance with vertical movement of the water surface in the tank 6a.

### (2) Configuration of Precipitate Removing Apparatus

As illustrated in FIGS. 2 and 3, the precipitate removing apparatus 50 according to the present example is for removing a precipitate P, precipitating on the bottom of the water tank 5d of the cooling tower 5. The precipitate removing apparatus 50 includes a plurality (ten in FIG. 3) of the injectors 9 provided in the water tank 5d of the cooling tower 5, and the introduction pipe 13 for introducing cooling water in the water tank 5d into the injectors 9.

The introduction pipe 13 is provided with a pressure pump 14 for pumping the cooling water in the water tank 5d into the injectors 9. The introduction pipe 13 is connected to the injectors 9 on its one end side. Specifically, the one end side of the introduction pipe 13 is branched into a plurality of branches each of which is connected at one end of the introduction pipe 13 to the corresponding one of the injectors 9. In addition, the introduction pipe 13 is connected at the other end to the feed path 2a of the cooling-tower-side circulation path 2.

The introduction pipe 13 is provided with a basket filter 16 (exemplified as “filter means” according to the present invention) for containing a water treatment agent made of an inorganic substance or the like so as to remove impurities contained in the cooling water, and the water impurity separation device 17 (exemplified as “filter means” according to the present invention) for removing impurities contained therein. Specifically, the basket filter 16 is provided in the introduction pipe 13 upstream of the pressure pump 14, and the water impurity separation device 17 is provided in the introduction pipe 13 downstream of the pressure pump 14. The water impurity separation device 17 is capable of removing impurities smaller than impurities that can be removed by the basket filter 16. The introduction pipe 13 is provided with a tourmaline treatment device 18 for forming tourmaline-treated water by bringing cooling water into contact with tourmaline granules. In addition, the introduction pipe 13 is provided with a bypass path 25, and the bypass path 25 is provided with a magnetic water treatment device 19 for magnetically treating cooling water.

The water impurity separation device 17 has a drain port 17a connected to a drain pipe 21 that is opened and closed by an on-off valve 22. The on-off valve 22 is controlled to be opened and closed by a control unit 24 in accordance with a detection value from a sensor 23 for detecting electric conductivity of cooling water. When the drain pipe 21 is opened, the cooling water is drained together with impurities from the drain port 17a of the water impurity separation device 17.

While the water impurity separation device 17 provided in the introduction pipe 13 is shown in the present example, the present invention is not limited to this. For example, the water impurity separation device 17 may be provided in the return path 2b (or the feed path 2a) of the cooling tower circulation path 2 instead of or in addition to the introduction pipe 13, as illustrated in FIG. 1 by an imaginary line. While the tourmaline treatment device 18 provided in the introduction pipe 13 is shown in the present example, the present invention is not limited to this. For example, the tourmaline treatment device 18 may be provided in the feed path 2a (or the return path 2b) of the cooling-tower-side circulation path 2 instead of or in addition to the introduction pipe 13, as illustrated in FIG. 1 by an imaginary line. In addition, the tourmaline treatment device 18 may be provided in a return path 3b (or the feed path 3a) described below of the chiller-machine-side circulation path 3, for example.

As illustrated in FIGS. 4 to 6, the injector 9 includes a small-diameter nozzle 52, a large-diameter nozzle 53 that is disposed so as to have an axis aligning with an axis of the small-diameter nozzle 52 and a discharge port 53a positioned downstream of a discharge port 52a of the small-diameter nozzle 52 in a discharge direction, and intake ports 54 for taking cooling water in the water tank 5d of the cooling tower 5 into the large-diameter nozzle 53 to generate negative pressure in front of the discharge port 52a of the small-diameter nozzle 52.

The large-diameter nozzle 53 has a rear end axially opposite to the discharge port 53a that is supported by the small-diameter nozzle 52 using a plurality of support pieces 55 (four in FIG. 5). The intake ports 54 are formed among the plurality of support pieces 55. The small-diameter nozzle 52 has a nozzle hole that decreases in diameter toward the discharge port 52a. The large-diameter nozzle 53 has a nozzle hole that increase in diameter toward the discharge port 53a. In addition, the discharge port 53a of the large-diameter nozzle 53 has an opening area more than an opening area of the discharge port 52a of the small-diameter nozzle 52.

As illustrated in FIG. 3, the water tank 5d of the cooling tower 5 is formed in a rectangular shape in plan view. The water tank 5d is provided at its bottom center with a recess 61 recessed downward. Then, a plurality (five each in the drawing) of the injectors 9 is juxtaposed along a pair of side walls of the water tank 5d, facing each other. In addition, a plurality (six in the drawing) of outflow ports 62 is formed in the periphery of the recess 61 at the bottom of the water tank 5d. The recess 61 of the water tank 5d is provided with an outflow port 63. Each of the outflow ports 62 and 63 is connected to one end of the feed path 2a of the cooling-tower-side circulation path 2 (refer to FIG. 2). In addition, the water tank 5ad of the cooling tower 5 is provided at its bottom with a plurality (six in the drawing) shielding walls 65 each erected at a position facing the corresponding one of the injectors 9 in its injection direction (or the discharge port 53a of the large-diameter nozzle 53) so as to surround the periphery of the corresponding one of the outflow ports 63. The shielding walls 65 are each disposed downstream of the corresponding one of the outflow ports 62 in the injection direction of the corresponding one to the injectors 9.

Each of the injectors 9 may be positioned and supported by the introduction pipe 13 in the water tank 5d, or may be positioned and supported by support means other than the introduction pipe 13 in the water tank 5d.

### (3) Action of Cooling Water Circulation System

Next, action of the cooling water circulation system 1 having the above configuration will be described. As illustrated in FIG. 1, cooling water circulating through the cooling-tower-side circulation path 2 is improved in water quality not only when flowing through the introduction pipe 13 by action of the basket filter 16, the water impurity separation device 17, the tourmaline treatment device 18, and the magnetic water treatment device 19, but also when being stored in the water tank 5d of the cooling tower 5 by action of the microbubble generator 40B. This causes the cooling water to not only be excellent in rust prevention and scaling resistance, but also have a cleaning function. Meanwhile, cooling water circulating through the chiller-machine-side circulation path 3 is improved in water quality not only by action of the water impurity separation device 17 and the microbubble generator 40A with a tourmaline treatment function, but also by action of the microbubble generator 40C when being stored in the tank 6a of the chiller machine 6. This causes the cooling water to not only be excellent in rust prevention and scaling resistance, but also have a cleaning function.

Then, circulating the cooling water improved in water quality through the respective circulation paths 2 and 3 suppresses the following problems due to deterioration in water quality of cooling water: adhesion, deposition, and clogging of a flow channel, of scales; corrosion, rust, and water leakage; and occurrence of slime and algae, in a mold cooling hole, a cooling pipe, a heat exchanger, and the like. As a result, the following various merits can be obtained: stable quality of a molding (a mold can be maintained at a constant temperature, and a silver defect due to insufficient cooling is less likely to occur); power saving and energy saving (large reduction in power consumption by increase in a heat exchange rate of a heat exchanger, reduction in the amount of emission of CO₂ through power saving and water saving, and reduction of trouble about abnormal high pressure of a heat exchanger); and large reduction in facility management cost (reduction of electricity charges for facilities, reduction of chemical cleaning cost, and reduction of cleaning maintenance cost).

In addition, the cooling-water circulation system 1 is configured such that when the electric valve 33 is opened by a timer function of the control unit 32, cooling water together with impurities is introduced into the return path 2b of the cooling-tower-side circulation path 2 from the drain port 17a of the water impurity separation device 17 via the first connection pipe 31. At this time, the differential pressure injector 36 injects cooling water (with a water pressure of 0.3 MPa, and at a flow rate of 1.8 L/min) flowing through the connection pipe 31, under a lower pressure and at a smaller flow rate than the cooling water (with a water pressure of 0.4 MPa, and at a flow rate of 120 L/min) flowing through a pipe constituting the cooling-tower-side circulation path 2, into the cooling water flowing through the pipe. Meanwhile, when the float valve 39 is operated in accordance with descent of the water surface of the tank 6a of the chiller machine 6, the cooling water flowing through the feed path 2a of the cooling-tower-side circulation path 2 is introduced to the tank 6a via the second connection pipe 38. That is, the cooling water contaminated in the chiller-machine-side circulation path 3 and the cooling water improved in water quality in the cooling-tower-side circulation path 2 are exchanged with each other.

The amount of water discharged from the water impurity separation device 17 is preferably set within 2% of the amount of circulating water in the chiller-machine-side circulation path 3 so as not to affect cooling efficiency of the chiller machine 6 in the chiller-machine-side circulation path 3 and the water is introduced into the return path 2b of the cooling-tower-side circulation path 2 from the constant flow valve 34 through the chuck valve 35. However, the amount of circulating water in the heat exchanger 6b varies by using the chiller machine 6, so that the constant flow valve 34 needs to be selected in terms of a drainage flow rate corresponding to specifications of the water impurity separation device 17.

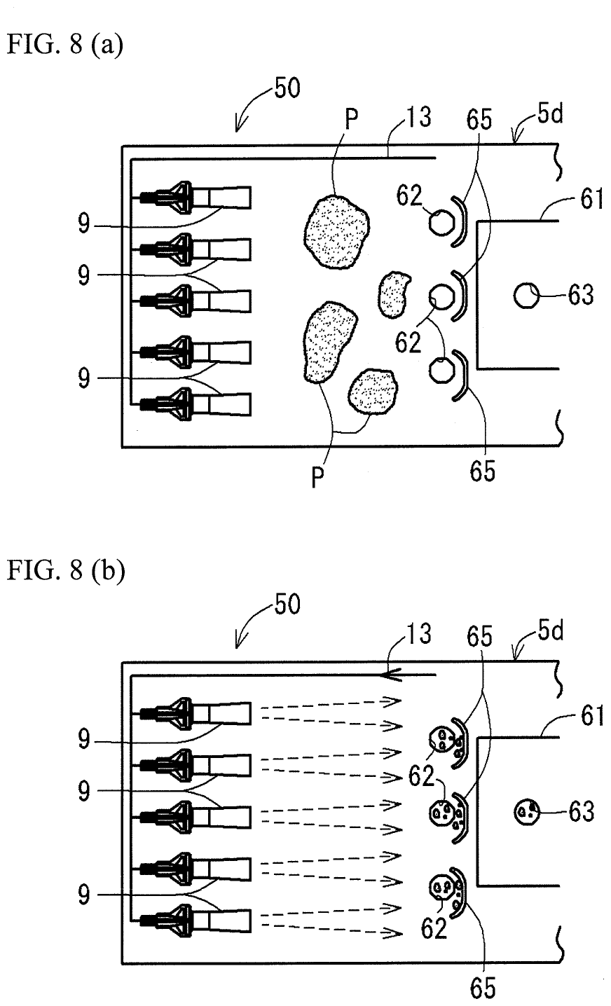

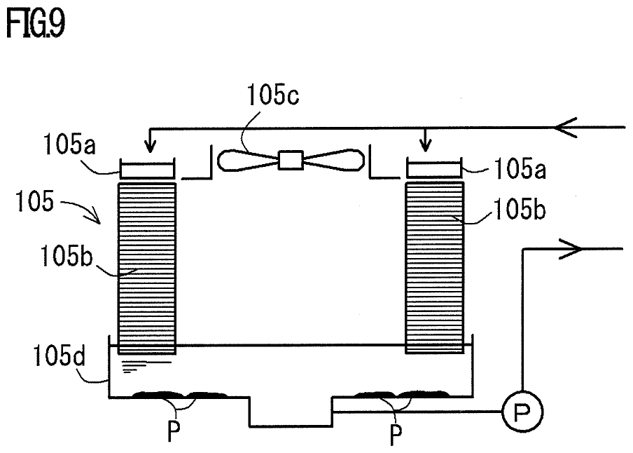

Here, action of the precipitate removing apparatus 50 will be described. While during operation of the cooling tower 5, dust and the like, together with the outside air, are mixed with cooling water in the water tank 5d in the tower, scales and the like adhering to the filling material 5b are peeled off to be mixed with the cooling water in the water tank 5d when the operation of the cooling tower 5 is stopped. The dust, scales, and the like mixed with the cooling water in the water tank 5d mix with bacteria, algae, and the like to cause slime to easily occur, so that a precipitate P may precipitate and accumulate on the bottom of the water tank 5d (refer to FIG. 8(a)). In this case, when the cooling tower 5 (or the cooling water circulation system 1) is restarted, the cooling water in the water tank 5d is pumped by the pressure pump 14 to the respective injectors 9 via the introduction pipe 13. Then, the respective injectors 9 inject the cooling water to remove the precipitate P from the bottom of the water tank 5d (refer to FIG. 8(b)). At this time, the precipitate P removed collides with the shielding wall 65, so that the precipitate is finely dispersed and smoothly guided into the outflow port 62 by the shielding wall 65.

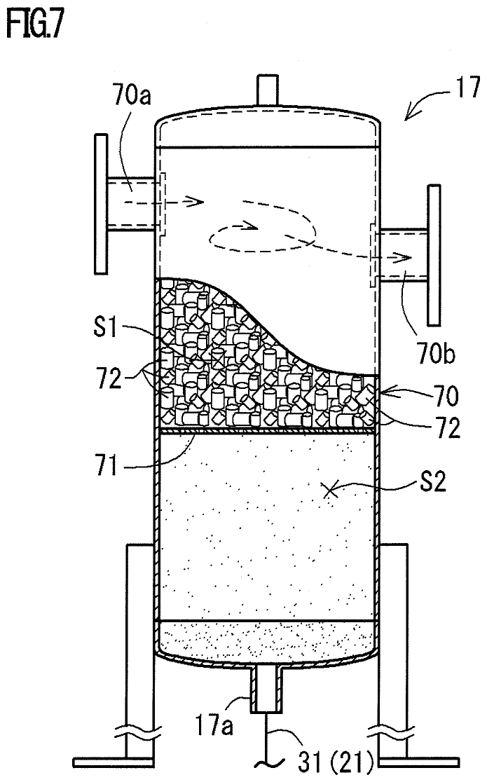

As illustrated in FIG. 6, each of the injectors 9 takes the cooling water in the water tank 5d into the large-diameter nozzle 53 through the intake ports 54 to cause negative pressure to be generated in front of the discharge port 52a of the small-diameter nozzle 52. The negative pressure causes suction force to draw out cooling water from the discharge port 52a of the small-diameter nozzle 52 at a higher flow velocity than the cooling water flowing through the introduction pipe 13. Then, cooling water taken in through the intake ports 54 is combined with the cooling water drawn out from the discharge port 52a of the small-diameter nozzle 52 to be injected toward the precipitate P through the discharge port 53a of the large-diameter nozzle 53.

### (4) Effect of Example

The precipitate removing apparatus 50 of the present example is configured to include the injector 9 provided in the water tank 5d of the cooling tower 5, and the introduction pipe 13 for introducing the cooling water in the water tank 5d into the injector 9, the introduction pipe 13 being provided with the pressure pump 14 for pumping the cooling water in the water tank 5d to the injector 9. This allows the pressure pump 14 to pump the cooling water in the water tank 5d into the injector 9 via the introduction pipe 13, and the injector 9 to inject the cooling water to remove the precipitate P from the bottom of the water tank 5d. As a result, the precipitate P, precipitating on the bottom of the water tank 5d can be easily removed.

The present example is configured such that the introduction pipe 13 is provided with the basket filter 16 and/or the water impurity separation device 17. This allows the basket filter 16 and/or the water impurity separation device 17 to remove impurities contained in the cooling water flowing through the introduction pipe 13, thereby improving the cooling water in water quality.

The present example is configured such that the introduction pipe 13 is provided with the basket filter 16 upstream of the pressure pump 14, and the introduction pipe 13 is provided with the water impurity separation device 17 downstream of the pressure pump 14, and such that the water impurity separation device 17 is capable of removing impurities smaller than impurities removable by the basket filter 16. This allows the basket filter 16 to remove relatively large impurities upstream of the pressure pump 14, and the water impurity separation device 17 to remove relatively small impurities downstream of the pressure pump 14. As a result, impurities can be effectively removed while damage or the like to the pressure pump 14 is prevented.

The present example is configured such that the injector 9 includes the small-diameter nozzle 52, the large-diameter nozzle 53, and the intake ports 54. This allows the cooling water in the water tank 5d to be taken into the large-diameter nozzle 53 through the intake ports 54, thereby causing negative pressure to be generated in front of the discharge port 52a of the small-diameter nozzle 52. The negative pressure causes suction force to draw out cooling water from the discharge port 52a of the small-diameter nozzle 52 at a higher flow velocity than the cooling water flowing through the introduction pipe 13. Then, cooling water taken in through the intake ports 54 is combined with the cooling water drawn out from the discharge port 52a of the small-diameter nozzle 52 to be injected toward the precipitate P through the discharge port 53a of the large-diameter nozzle 53. This enables the precipitate P to be removed by the cooling water injected by the injector 9 having a simple structure.

The present example is configured such that the large-diameter nozzle 53 is supported by the small-diameter nozzle 52 using the plurality of support pieces 55, and the intake ports 54 are formed among the plurality of support pieces 55. As a result, the cooling water is effectively taken into the large-diameter nozzle 53 from the intake ports 54 to generate a larger negative pressure in front of the discharge port 52a of the small-diameter nozzle 52. This further increases the injection force of the injector 9.

The present example is configured such that the large diameter nozzle 53 is provided with a nozzle hole formed in a tapered shape increasing in diameter toward the discharge port 53a. This widens the injection range of the injector 9.

The present example is configured such that the plurality of the injectors 9 is juxtaposed along the side wall of the water tank 5d of the cooling tower 5. This enables the plurality of the injectors 9 to remove precipitates P, precipitating over a wide range on the bottom of the water tank 5d using, cooling water injected by the injectors.

The present example is configured such that the water tank 5d of the cooling tower 5 is provided at its bottom with the outflow port 62, and the shielding walls 65 erected. This causes the precipitate P removed from the bottom of the water tank 5d using the cooling water injected by the injectors 9 to collide with the shielding wall 65. Then, the precipitate P is finely dispersed and smoothly guided into the outflow port 62 (or the introduction pipe 13) by the shielding wall 65.

In addition, the present example is configured such that the introduction pipe 13 has one end connected to the injector 9, and the other end connected to the feed path 2a of the cooling-tower-side circulation path 2. This enables the introduction pipe 13, and thus the apparatus, to be easily installed.

The cooling water circulation system 1 of the present example is configured such that the precipitate removing apparatus 50 described above is provided and the injector 9 is provided in the water tank 5d provided in the cooling tower 5. This allows the pressure pump 14 to pump the cooling water in the water tank 5d into the injector 9 via the introduction pipe 13 during the operation of the cooling tower 5, so that the precipitate P is removed from the bottom of the water tank 5d using the cooling water injected by the injector 9. As a result, the precipitate P, precipitating on the bottom of the water tank 5d of the cooling tower 5, can be easily removed.

The present invention is not limited to the example described above, and can be variously modified within the scope of the present invention depending on purpose and use. That is, while there is exemplified the introduction pipe 13 that is connected at one end to the cooling-tower-side circulation path 2 in the example described above, the introduction pipe 13 is not limited to this. For example, the introduction pipe 13 may be directly connected at one end to the outflow ports 62 and 63 of the water tank 5d.

While the example described above is configured such that the introduction pipe 13 is provided with the filter means (the basket filter 16 and the water impurity separation device 17) upstream of the pressure pump 14 and downstream thereof, the present invention is not limited to this. For example, the introduction pipe 13 may be provided with the filter means only upstream or downstream of the pressure pump 14, or the introduction pipe 13 may be provided with no filter means.

While there is exemplified the injector 9 including the small-diameter nozzle 52, the large-diameter nozzle 53, and the intake ports 54, in the example described above, the injector 9 is not limited to this. For example, the injector 9 may include a single nozzle.

In addition, while the example described above is configured such that a plurality of the injectors 9 is juxtaposed along each of two side walls of the water tank 5d, the present invention is not limited to this. For example, as long as precipitates can be removed over the entire bottom of the water tank 5d, the number of the injectors 9, a placement form thereof, and the like are not particularly limited. For example, a plurality of the injectors 9 may be juxtaposed along one side wall of the water tank 5d, or each of three or more sides thereof.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

### INDUSTRIAL APPLICABILITY

The present invention is widely used as a technique for removing a precipitate, precipitating on the bottom of a water tank for storing liquid, the water tank being used in industrial fields, medical fields, agricultural fields, environmental fields, food fields, and the like. In particular, it is suitably used as a technique for removing a precipitate, precipitating on the bottom of a water tank of a cooling tower.

### REFERENCE SIGNS LIST

1 cooling water circulation system
2 cooling-tower-side circulation path
2a feed path
5 cooling tower
5d water tank
6 chiller machine
9 injector
13 introduction pipe
14 pressure pump
16 basket filter
17 water impurity separation device
50 precipitate removing apparatus
52 small-diameter nozzle
52a discharge port
53 large-diameter nozzle
53a discharge port
54 intake port
55 support piece
62 outflow port
65 shielding wall
P precipitate

1. A precipitate removing apparatus for removing a precipitate, precipitating on the bottom of a water tank that stores a liquid, the precipitate removing apparatus comprising:
an injector provided in the water tank; and
an introduction pipe for introducing a liquid in the water tank to the injector,
the introduction pipe being provided with a pressure pump for pumping the liquid in the water tank to the injector.

2. The precipitate removing apparatus according to claim 1, wherein
the introducing pipe is provided with filter means for removing impurities contained in the liquid flowing through the introducing pipe.

3. The precipitate removing apparatus according to claim 1, wherein
the injector includes a small-diameter nozzle, a large-diameter nozzle that is disposed so as to have an axis aligning with an axis of the small-diameter nozzle and a discharge port positioned downstream of a discharge port of the small-diameter nozzle in a discharge direction, and intake ports for taking the liquid in the water tank into the large-diameter nozzle to generate negative pressure in front of the discharge port of the small-diameter nozzle.

4. The precipitate removing apparatus according to claim 3, wherein
the large-diameter nozzle is supported by the small-diameter nozzle using a plurality of support pieces, and
the intake ports are formed among the plurality of support pieces.

5. The precipitate removing apparatus according to claim 3, wherein
the large diameter nozzle is provided with a nozzle hole formed in a tapered shape increasing in diameter toward the discharge port.

6. The precipitate removing apparatus according to claim 1, wherein
a plurality of the injectors are juxtaposed along a side wall of the water tank.

7. The precipitate removing apparatus according to claim 1, wherein
the water tank is provided at its bottom with an outflow port communicating with the introduction pipe, and a shielding wall erected at a position facing an injection direction of the injector while surrounding a periphery of the outflow port.

8. The precipitate removing apparatus according to claim 1, wherein
the injector is provided in the water tank provided in the cooling tower.

9. The precipitate removing apparatus according to claim 8, wherein
the introduction pipe has one end connected to the injector, and the other end connected to a feed path of a cooling-tower-side circulation path for circulating cooling water between the cooling tower and a chiller machine.

10. A cooling water circulation system comprising:
a cooling-tower-side circulation path for circulating cooling water between a cooling tower and a chiller machine; and
the precipitate removing apparatus according to claim 1,
wherein the injector is provided in the water tank provided in the cooling tower.
